(19) United States
(12) Patent Application Publication
(10) Pub. No.: US 2011/0022474 A1
(43) Pub. Date: Jan. 27, 2011

(54) Secure Access Personal Entertainment Area with Advertising Based on Travel Destination

(76) Inventors: Pranay Jain, Jersey City, NJ (US); Virat Agarwal, White Plains, NY (US)

Correspondence Address: Law Office of Michael J. Feigin, 103 The Circle, (http://PatentLawNY.com), Passaic, NJ, 07055, US

(21) Appl. No.: 12/508,923

(22) Filed: Jul. 24, 2009

(51) Int. Cl. G06Q 30/00; G06K 5/00

(52) U.S. Cl. 705/14.66; 235/382

(57) ABSTRACT

The technology disclosed herein provides methods and devices for providing advertising to travelers at travel points based on a destination of travel, the destination information gleaned from a user identification document such as a credit card, travel ticket, or the like. Embodiments of the disclosed technology provide a secure access personal entertainment area at a travel point comprising an electronically secured entrance user input receiving device to glean data from user access identification documents. Within the secure entertainment area is a plurality of entertainment activities. Further, within this area, advertisements exhibited to the user of the secure access personal entertainment area are based, at least in part, upon user interaction with the plurality of entertainment activities.

### FIELD OF THE DISCLOSED TECHNOLOGY

The disclosed technology relates generally to rest areas, and more specifically, to secure rest areas with specific advertising.

### BACKGROUND OF THE DISCLOSED TECHNOLOGY

Traveling, as is known in the art, is often fraught with long wait times, including layovers, pit stops, delays, transfers, and the like. Whether one is travelling by plane, train, bus, or automobile, such wait times are an inevitable and burdensome inconvenience. When a train or airplane is delayed, the long lay-over at a transfer station or airport can adversely affect a person's vacation or greatly fatigue a businessman in advance of the appointments awaiting him at his destination. Travel hubs, such as airports and train stations, are known to be stressful and tiresome places; extended sojourns there increase the discomfort of travel.

Even highway rest stops, where a trip may be interrupted selectively, are more often than not undesirable. For example, when traffic is heavy, driving may be stressful, making it necessary for the driver and passengers to take a break from the road. Of course, a driver or passenger may need to eat and/or use the bathroom. Thus, the stops tend to be out of necessity and are rarely thought of as an enjoyable part of a trip.

Therefore, there is a need in the art to decrease stressfulness and frustration at travel points, such as waiting areas during layovers, rest stops, travel hubs, and the like. In this area, the quality of life leaves much to be desired. While the prior art devices provide forms of entertainment and/or leisure to the traveler, the problem of creating restful and low stress environments at travel points has met with limited commercial solutions.

U.S. Pat. No. 3,553,911 to Morrow et al., U.S. Pat. No. 4,594,817 to McLaren, U.S. Pat. No. 5,111,626 to Fortune, and U.S. Pat. No. 5,638,646 to Shane, disclose a variety of booths provided for travelers. Various entertainment services are offered, including television, lounge chairs, and the like. While Morrow, McLaren, Fortune, and Shane provide several types of entertainment and/or leisure on a pay-per-use basis. However the cost of operation and the cost of purchasing use thereof, especially at high rent travel points, has limited the commercial success of these devices.

There is a need in the art to provide a method of making available comfort and leisure to travelers that is economically viable, so as to reduce the stress of travelers and increase consumer satisfaction with the travel industry.

### SUMMARY OF THE DISCLOSED TECHNOLOGY

It is therefore an object of the disclosed technology to provide a profitable, yet affordable, safe, secure, and comfortable area for travelers to rest at a travel point on the way to their final destination.

It is a further object of the disclosed technology to tailor advertising to users of such an area or space to ensure greater interaction rates for advertisements exhibited to a user.

It is yet a further object of the disclosed technology to achieve greater advertising penetration rates by determining the origin and/or destination of a user of the system, so as to provide more relevant advertising.

Embodiments of the disclosed technology provide a secure access personal entertainment area at a travel point comprising an electronically secured entrance. The electronically secure entrance further comprises a user input receiving device. The user input receiving device is configured to glean data from user access identification documents, such as credit cards, passports, driver's licenses, and tickets for trains, planes, and the like. Upon gleaning such data, the electronically secure entrance (e.g., electronic console or electronic console combined with a human attendant) grants access to a secure entertainment area. Within the secure entertainment area is a plurality of entertainment activities. Further, within this area, advertisements are exhibited to the user based, at least in part, upon a point of travel gleaned from a user access identification document.

The secure access personal entertainment area may be an individual booth or console for each user.

The user input receiving device may be a card reader, which reads data from a user identification document, such as a credit card or travel ticket. The user input receiving device may further comprise a combination of these types of readers used to glean data from a user identification document.

The point of travel may be an origin of travel, and the origin may be determined based on data gleaned from the user access identification document, such as a ticket purchase location, the ticket being employed by the user to gain access to the secure area, or a billing address, which may be determined by reading data from a user's credit card, passport, or driver's license.

The point of travel may be a destination of travel. When the point of travel is a destination of travel, the user access identification document may be a ticket granting travel privileges to the user, such as a plane ticket, train pass, and the like. Further still, access to the secure access personal entertainment area may be granted only after the user input receiving device has gleaned the data from the ticket.

In embodiments of the disclosed technology, the advertisements directed toward the user may be based on a class of ticket used to gain entry, such as a first class, business class, or coach ticket. Further, the advertisements may be based on an ethnicity of the user. Ethnicity may be determined based upon, but not limited to, the person's name and/or an origin of travel gleaned from the user access identification document.

An entertainment activity within the plurality of entertainment activities may include a media offering (e.g., music or videos), shopping for goods and services, and so forth. Music selection may be provided based on the data gleaned from the ticket. The advertisements directed toward the user may be based on such factors, e.g., based on the music listened to by the user or the goods and services selected for viewing while shopping.

In further embodiments of the disclosed technology, the destination and/or sophistication (e.g., expensive goods and services purchased or inexpensive goods and services purchased) of the user may be determined based, at least in part, on advertisements acted upon by the user. An advertisement is acted upon when, for example, a user clicks on a displayed ad or purchases a product or service offering exhibited in an advertisement. Advertisements may also be based, at least in part, on the time of day.

In yet another embodiment of the disclosed technology, a method for employing the devices and systems described hereinabove to provide targeted advertisements to an individual (e.g. user) using the secure access personal entertainment area is disclosed.

### BRIEF DESCRIPTION OF THE DRAWINGS

FIG. 1 shows a layout of secure access areas with consoles in an embodiment of the disclosed technology.

FIG. 2 shows a high level diagram of devices and areas which may be used to affect advertisements in a secure access area in an embodiment of the disclosed technology.

FIG. 3 shows a high level diagram of devices and user inputs having an effect on advertisements in an embodiment of disclosed technology.

FIG. 4 shows a high level diagram of processes and further inputs having an effect on advertisements in an embodiment of the disclosed technology.

FIG. 5 shows an example of a graphical user interface that exhibits media entertainment as well as advertisements in an embodiment of the disclosed technology.

FIG. 6 shows a high-level block diagram of a console that may be used to carry out the disclosed technology.

### DETAILED DESCRIPTION OF EMBODIMENTS OF THE DISCLOSED TECHNOLOGY

Embodiments of the disclosed technology present a profitable (to the provider), yet affordable (to the user), safe, secure, and comfortable area for travelers (e.g., vacationers, businessmen, etc.) to rest at a travel point (e.g., train station, airport, highway rest stop, etc.), on the way to their ultimate destination. These areas comprise a secure access personal entertainment area that provides a wide selection/plurality of entertainment activities (as explained further below) along with advertisements targeted toward the traveler based, at least partially, on information that the traveler provides. In embodiments of the disclosed technology, such information is provided at the time of the traveler's entry into the secure area, such as by gleaning credit card, ticket, passport, and/or driver's license data. In still further embodiments, such information is gleaned based on media preferences, advertisements acted upon by the user, and the like. Thus, the advertisements are targeted at the user based on such data.

The secure access personal entertainment area comprises a designated section at a travel point (physical location for temporary stopover while traveling, such as a roadside rest stop, or a hub comprising points of embarkation for a mode of transit, such as a plane, train, bus, or the like). In such a designated section, a user has a place of relaxation which is, at least partially, financed by the use of advertising. The designated section or, hereinafter, the secure access personal entertainment area, in embodiments of the disclosed technology, offers a plurality of entertainment activities. Examples of such entertainment include comfort seating, a closed private room, media offerings (e.g., video, music), trivia, weather information, internet access, shopping, and the like.

In embodiments, the user gains access to the secure area by using an access identification document with a user input receiving device. An access identification document may be any article (e.g., a plane ticket, a credit card, a driver's license, a passport, etc.) that contains verifiable information about the user or his travels (residence, origin of travel, destination of travel, etc.) The user input device is any mechanism that can glean such information from the user's access identification document and takes part in the process of gleaning data from the user or granting access to the secure access personal entertainment area. Such a device may also have the capabilities to, but is not limited to, storing and receiving the information gleaned, collecting and transferring payments for access, and any other function that involves collecting and sending informational data. Such information, besides granting access to the secure area, is also used to generate direct advertising for the user. Payments may be charged to a user, by way of methods known in the art, for access to a secure area.

The data gleaned from the access identification document(s), in embodiments of the disclosed technology, are sent to a console where they are used as a factor in calculating which advertisements should be displayed. Such advertisements may be based on a point of origin or a destination of travel of the user. A point of origin or a destination of travel may be dependent on the type of user identification document that is being read. For example, a credit card may give a billing address, a passport may provide a residential address, a travel ticket may provide a ticket purchase location or travel destination, etc. One or more of these items of data, in embodiments of the disclosed technology, is used to determine origins and/or destinations of travel and show appropriate advertisements. Furthermore, other factors used in determining the information displayed may be based on data gleaned from the user's interactions with the entertainment activities.

The disclosed technology will become clearer in light of the description of the figures.

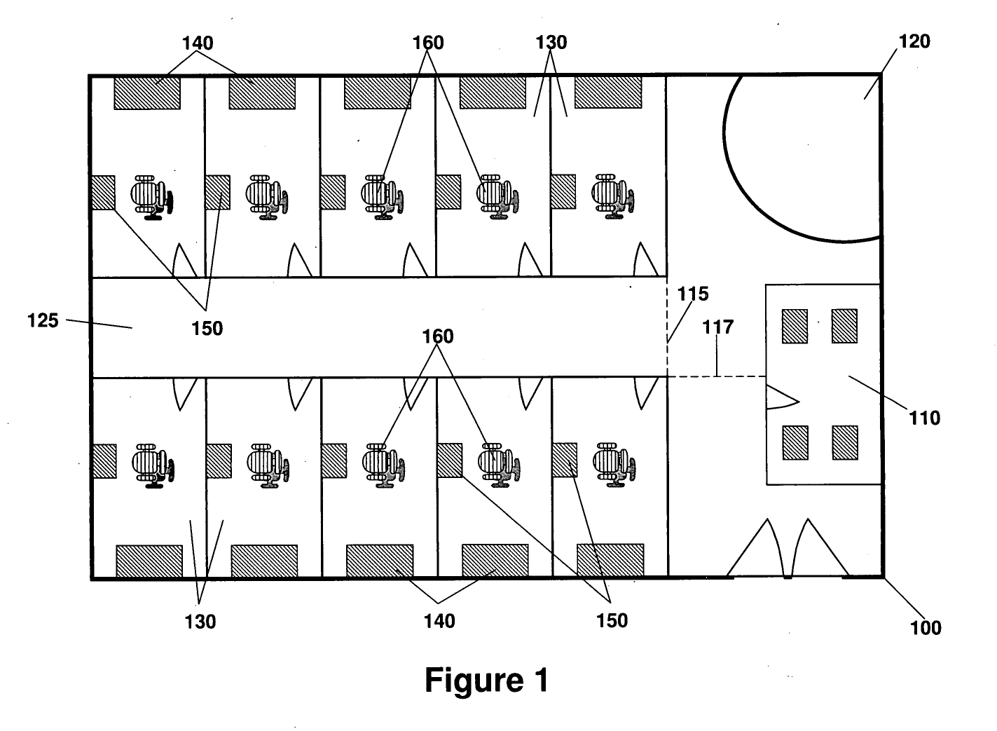

FIG. 1 shows a layout of secure access areas with consoles in an embodiment of the disclosed technology. It should, of course, be understood that any layout may be used and the layout shown in FIG. 1 is shown only by way of example. Within an area 100, such as an area at a travel point, several secure access entertainment areas 130 are shown with entertainment consoles 140. Other features, in embodiments of the disclosed technology, include items such as a business center and/or offices 110, a food and/or refreshment bar 120 or other common area, and a gallery 125 leading from the common area to each secure access entertainment area 130. To gain access to a secure access entertainment area 130, a user provides access identification documents at a user input receiving device (not shown).

In the example shown in FIG. 1, the user input device is located either at the business center or offices 110, the entrance of the common area 115, the entrance of the gallery 117, or at each door leading to each secure access entertainment area 130. In FIG. 1, a secure access information area 130 is comprised of an individual booth. It should be known that a secure information access area need not be an individual booth and, furthermore, a secure access entertainment area may or may not have walls. In such an embodiment where there are no walls, the entertainment console 140 may or does comprise the user input receiving device. Thus, the console 140, itself, may have means, such as a card or ticket reader or scanner, for receiving user identification documentation and the like. The user input receiving device is at any of these locations or, in embodiments, there are multiple user input receiving devices at one or more locations, such as a first user input receiving device to glean data from a ticket and a second user input receiving device to glean data from a credit card.

In embodiments of the disclosed technology, within the secure access personal entertainment area 130, there is a plurality of entertainment activities. Such entertainment activities may or do include advance comfort seating 160, an entertainment console 140, and a work space 150. The workspace may include, but is not limited to, office services such as a printer, a facsimile machine, voice mail receiver, voiceover Internet protocol, teleconference devices, and a television.

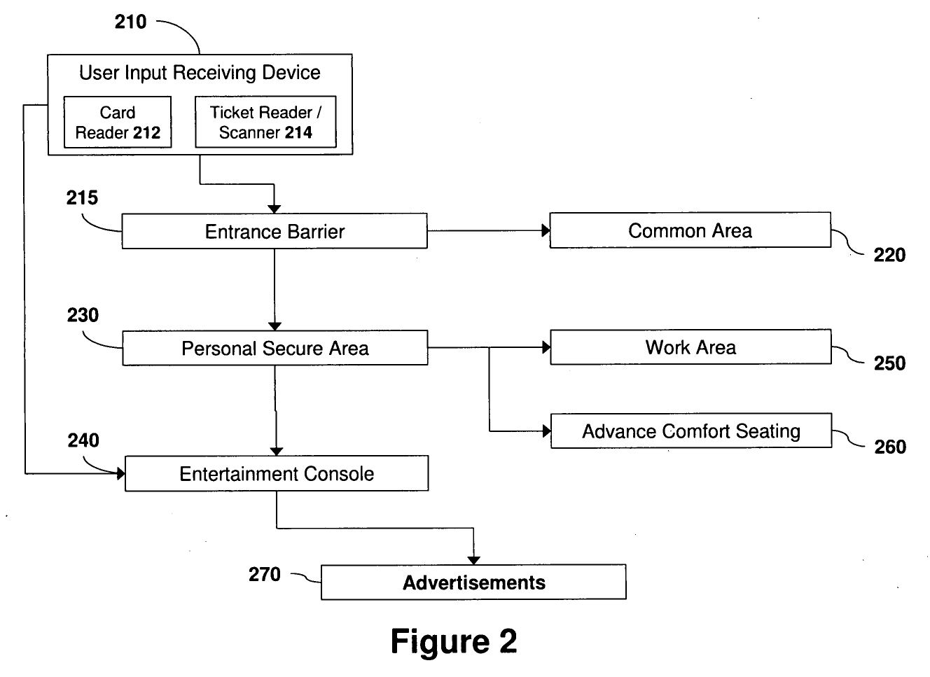

FIG. 2 shows a high level diagram of devices and areas which may be used to affect advertisements in a secure access area in an embodiment of the disclosed technology. In general, the devices of FIG. 1 have been increased by 100 when used in FIG. 2. In the example shown, a user input receiving device 210 gleans data from a user identification document. The user input receiving device, in embodiments of the disclosed technology, comprises any one of, or a plurality of, card readers 212, such as a credit card reader, passport reader, driver's license reader, ticket reader, optical scanner, magnetic scanner, RFID receiver, a combination thereof, or the like. The user input receiving device 210, in embodiments of the disclosed technology, may instead or also comprise of a ticket reader or scanner 214. The ticket reader or scanner is a device that gleans data and/or payment information from a travel ticket, the ticket being a commercial document showing that a user is entitled to have access to travel on a transportation mechanism. The ticket may also comprise data granting access to the secure entertainment area 130 and/or console 140 based on prepayment for the entertainment area with purchase of the ticket or the entertainment area services being included with a ticket purchase. Examples of travel tickets include a plane boarding pass, a train ticket, a bus ticket, or a highway exit toll ticket. In still further embodiments, a credit card or other payment mechanism is used and charged before granting access. In other embodiments still, the user is not charged, but the user input receiving device 210 must glean data from a specific type of, or subset of, tickets and other user identification documents, so as to determine targeted advertisements exhibited to the user.

The user input receiving device 210 may be an integral part of (either physically or by way of a data network) an entrance barrier 215 and/or entertainment console 240. Alternatively, the user input receiving device 210 may pass information gleaned from a user access document (as described above) to the entrance barrier 215, so as to allow entry of a user into a personal secure entertainment area 230 and/or an entertainment console 240.

The entrance barrier 215 is a barrier to entry of a physical space in embodiments of the disclosed technology. Such a physical space may comprise either or both of a common area 220 (corresponding to the refreshment bar area 120 of FIG. 1) or a personal secure area 230 (e.g., a secure access physical space dedicated to an individual user or his party). The personal secure area 230, in embodiments of the disclosed technology, has a plurality of entertainment activities such as a work area 250 (e.g., desk), advanced comfort seating 260, and an entertainment console 240. In other embodiments of the disclosed technology, the entrance barrier 215 is a barrier to the use of a console 240. It should also be understood that a user may be charged or required to make a payment before being granted access to/receiving access to a personal secure area 230 or console 240.

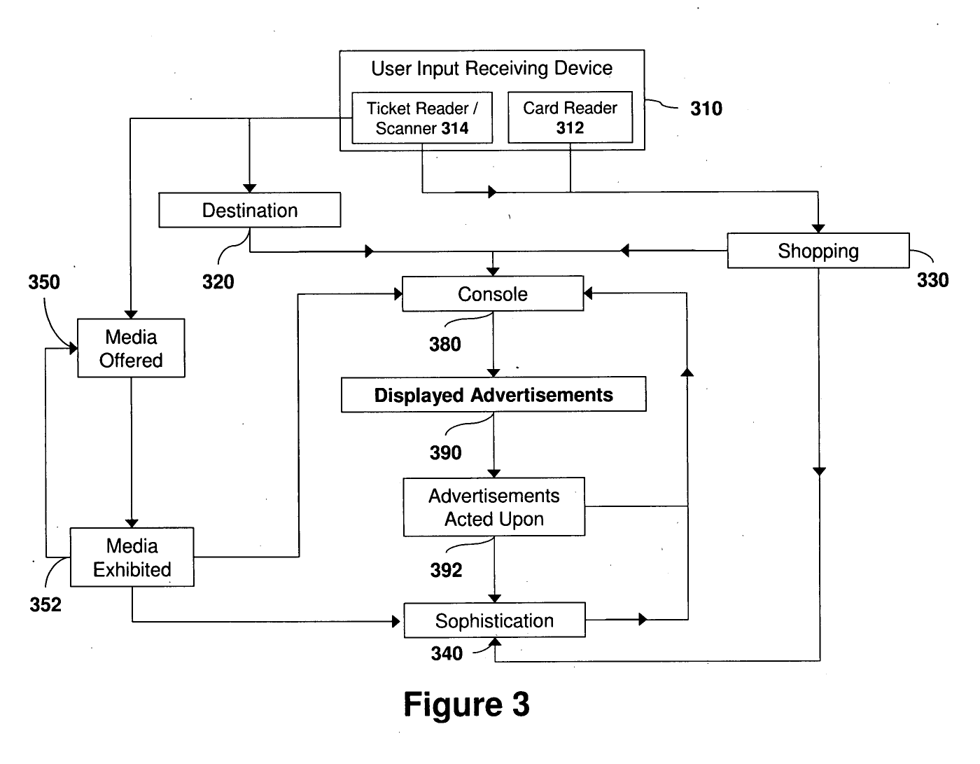

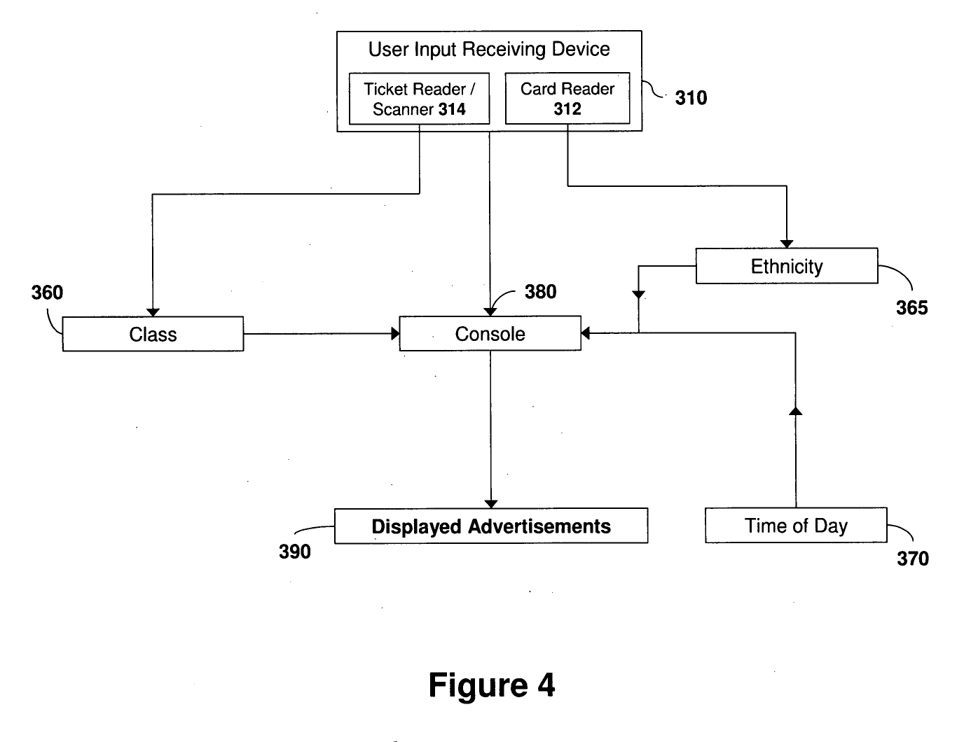

Based on data received by the entertainment console 240 from the user input receiving device 210, as well as data gleaned from user interaction thereof, advertisements 270 are displayed on the entertainment console. It should be understood that where “console” or “entertainment console” are used in the description of embodiments of the disclosed technology, this may refer to a dedicated computing device employed by a user described herein, an off-site computing device, a networked computing device or server, a person making selections of advertising to display, or combinations thereof. More detailed parameters of how advertisements are chosen for display on a console 240 are described herein below with reference to FIGS. 3 and 4.

FIG. 3 shows a high level diagram of devices and user inputs having an effect on advertisements in an embodiment of disclosed technology. In general, the devices of FIG. 1 have been increased by 200 and devices in FIG. 2 have been increased by 100 when used in FIG. 3. Furthermore, it should also be understood that FIG. 3 is an example and does not fully display all of the factors that may be used to determine displayed advertising. In an embodiment of the disclosed technology, the user input receiving device 310 sends the data that a ticket reader/scanner 314 gleaned from a travel ticket for the primary purpose of properly selecting advertisements displayed 390. In an embodiment of the disclosed technology, the destination 320 and/or origin of travel of the user is deduced from the data gleaned from a travel ticket by a ticket reader/scanner 314, a human receptionist, or a combination thereof. Furthermore, in an embodiment of the disclosed technology, the data gleaned by the ticket reader/scanner 314 and/or a card reader 312 is used to generate a proper selection of shopping 330 opportunities and media offered 350 to the user.

In an embodiment of the disclosed technology, the media offered 350 are comprised of visual and audio entertainment exhibited on a display screen, loudspeakers, or a combination thereof. Examples of such media include, but are not limited to, an offering of movies, music, and television. Furthermore, the data gleaned from the user input receiving device 310 is used as a contributing factor in the selection of the media offered. In an embodiment of the disclosed technology, factors used to determine a selection of media offered include an origin of travel, a destination of travel, a current residence, the name of a user, or a combination of these elements. Any media exhibited 352 (e.g., videos watched, music listened to, etc.) are further used in determining media offered 350, sophistication (as described further below) 340, and/or further analysis of advertising to display on a console 380.

In the example as shown in FIG. 3, shopping 330 opportunities are provided after user access documents are applied in conjunction with a user input receiving device 310. Shopping 330 opportunities are offered based partially on the information gleaned from a ticket reader/scanner 314, a card reader 312, or from a combination thereof. The shopping opportunities 330 provided are offered either on-line, by a catalogue, by a human, with a network console, with a user interface, vending machine, online duty free purchases, or a combination of these. Furthermore, in an embodiment of the disclosed technology, data is gleaned from goods and services viewed and/or purchased while shopping 314 by a console, a human, a mechanical recording device, or a combination thereof, where it is then used to determine advertisements of further goods to exhibit to the user. This may be in combination with the data about travel origin or destination to display an advertisement to the user. The advertisement displayed may further be exhibited as a result of the media listened to 352, sophistication 340, and so forth.

In an embodiment of the disclosed technology, sophistication 340 of a traveler is a general demographical categorization of a traveler used to determine advertisements 390 to exhibit to the user, such as the type of travel or class of travel (e.g., first class plane vs. coach bus), willingness to spend money on goods and type of goods purchased/viewed (e.g., purchase of a $1,000 watch vs. purchase of a t-shirt), and music listened to (e.g., classical vs. children's music). Sophistication 340 of a traveler is determined by the console, a person, or a combination thereof, based on at least some of the information gleaned from media exhibited 352, shopping 330, class of ticket, advertisements acted upon, and any further interactions within a secure access personal entertainment area.

In an embodiment of the disclosed technology, as seen in the example in FIG. 3, data gleaned by a user input receiving device 310 and from interactions involving a secure access personal entertainment area are sent to a console 380 to determine information such as the best selection of advertisements displayed 390, a selection of media to offer 350, shopping opportunities, and the like. In this example, a console takes data gleaned by user input receiving device 310 (such information may include, but is not limited to, credit card number, ticket number or any distinguishing factors of a traveling ticket, name, destination/origin of travels, payment information, etc.), along with data gathered from user interactions involving the personal entertainment area (media exhibited 352, shopping 330, sophistication 340, advertisements acted upon 392, and the like), and then use these data along with other market research, as is known in the art of advertising, to compute which advertisements would be most valuable to show to a specific user. Furthermore, in an embodiment of the disclosed technology, a console 380 may be a separated device unto itself (an example of which is a computer) or may be part of another device in the console, or it can be part of another device that is involved with the personal access entertainment area.

In an embodiment of the disclosed technology, the advertisements displayed 390 are interacted with by a user if the user is interested in the offerings of the advertisement. In a further embodiment, for advertisements acted upon 392 on a console, a user is able to interact with the advertisements by engaging with a graphical user interface that would allow a user to purchase goods and services offered. Examples of such interaction include selecting a displayed button, playing a trivia quiz, clicking on a link, closing the advertisement, rating the advertisement, etc. Furthermore, in embodiments of the disclosed technology, a user may also interact with displayed advertisements 390 that are exposed anywhere within the secure access personal entertainment area. Examples of this include activating a switch mechanism such as a depressible push button, interacting with a human seller, or engaging in a multiple step process acquiring more advertising and/or information on the goods and services offered, etc. In an embodiment of the disclosed technology, advertisements acted upon lead to an opportunity to actually purchase the goods and services offered. Purchasing of goods and services in reaction to advertisements requires an equitable exchange, which is done by an offering of cash, providing billing information for a monetary exchange (which may have already been provided to a user input receiving device), an offering of personal information, or a combination thereof. Additionally, advertisements acted upon 392 are used to further determine, destination 320 (e.g., a person in an international airport from which flights take off for Hawaii, who is clicking on Hawaii car rental information, would be deemed to be flying to Hawaii, and the destination determined would be used to show relevant advertising), point of origin, media offered 352, sophistication 340, shopping, further displayed advertisements 390, other information that is producible in the console 380, or a combination of any of these elements.

As a real life example of a method of displaying advertisements based on some of the elements of FIG. 3 follows. Upon a user having his credit card read by a card reader 312 and his ticket scanned by a ticket reader 314, the user input receiving device passes data to a console 380 which determines, based on the ticket data, that the destination 320 is Hawaii. The user's credit card is charged for use of the secure access personal entertainment area. Amongst the advertisements displayed 390 on a console 380 are those for Hawaii-related items, so as to allow the user to go shopping 330. These items may include towels, umbrellas, sunscreen, and hand-made art from volcanic rocks. The user may purchase the art indicated at a higher level of sophistication 340. Also, considering the fact that the user is traveling to Hawaii, he/she may be considered to have a greater sophistication, at least at the outset. Still further, media offered 350 may include nature videos on Hawaii, general cartoons, and a music selection including local Hawaiian bands and top 40 music. Based on the media selection, advertisements may further be displayed and a sophistication level may further be determined to aid in the types of advertisements displayed. Thus, as a result of the foregoing, more relevant music selections and advertisements may be provided, such as ads for luxury condo rentals in Hawaii and artwork sold in a specialty shop within the airport, and the like, as opposed to, say, advertisements for the fast food restaurant in the airport.

FIG. 4 shows a high level diagram of processes and further inputs having an effect on advertisements in an embodiment of the disclosed technology. In general, the example shown in FIG. 4 can be used in conjunction with the example shown in FIG. 3. Accordingly, the numbering of the devices in FIG. 4 is consistent with the numbering in FIG. 3. As in the previous example, information about the user is gleaned by the user input receiving device 310.

In an embodiment of the disclosed technology, as shown in FIG. 4, information gleaned is then further used to discern a user's class 365. Class 365 is defined as class of accommodation on a train, passenger ship, airplane, or other conveyance. Such examples of class are first, economy, and business class. Class is useful information because it is an excellent indicator of a person's disposable income. In the example shown, the datum of the class is transferred to the console 380 for further informational analysis. Class can also be used to directly discern the best advertisements to show to a user.

In the example in FIG. 4, information gleaned from a user can be applied to determine ethnicity 365. The ethnicity 365 is defined here as a characterization of people by real or presumed distinctive characteristics involving common cultural, age, religious, behavioral, sexual, or biological traits. In an embodiment of the disclosed technology, the ethnicity 365 of a user is determined by analysis, either directly or done in a console 380, of a person's name, gender, origin and destination 320 of travel, billing address, current residence, media exhibited 352, shopping 330, and the like. Once the ethnicity is determined, it is used for further analysis within a console 380.

In an embodiment of the disclosed technology, data not gleaned directly from information provided by the user, such as the time of day 370, can also be used in the console 380 to generate useful information. Other examples include, but are not limited to, existing services at the current traveling point, weather, time of year, upcoming holidays, and other external variables.

Furthermore, as shown in the example in FIG. 4, the data gleaned by the user input receiving device 310, as well as all other external and internal data gleaned, is collected in a console 380. In an embodiment of the disclosed technology, a console is able to use the data it has received to determine which displayed advertisements 390 would be more useful to exhibit than other advertisements that might have been selected not using such data. Furthermore, a console is also able to use all the data that it receives to generate additional data that can be used for other segments of the plurality of entertainment activities.

In an example of an implementation of the elements shown and described with respect to FIG. 4, a user identification document may be a credit card read by the card reader 312. Based on credit card data, it may be determined that a person's first name is “Neha” and the billing address is in India. With these data, it can be determined with reasonable certainty that the user is of Indian origin or ancestry, and advertisements displayed should be in accord with what is appealing to such a person. It can also be determined with reasonable certainty that such a name is female and, as a result, advertisements directed more towards a female demographic should be exhibited. If Neha is traveling in a first class 360 compartment of a train, then, based on this class 360, the sophistication and type of ads to display to Neha may be determined before adjusting for media listened to, ads clicked on, and the like. Still further, if Neha enters the secure access personal area at 4 am, the ads displayed may be different from those if she were to enter at 4 pm, based on the types of things that such a person thinks about at a given hour and/or the fact that the person is traveling at a certain time of day.

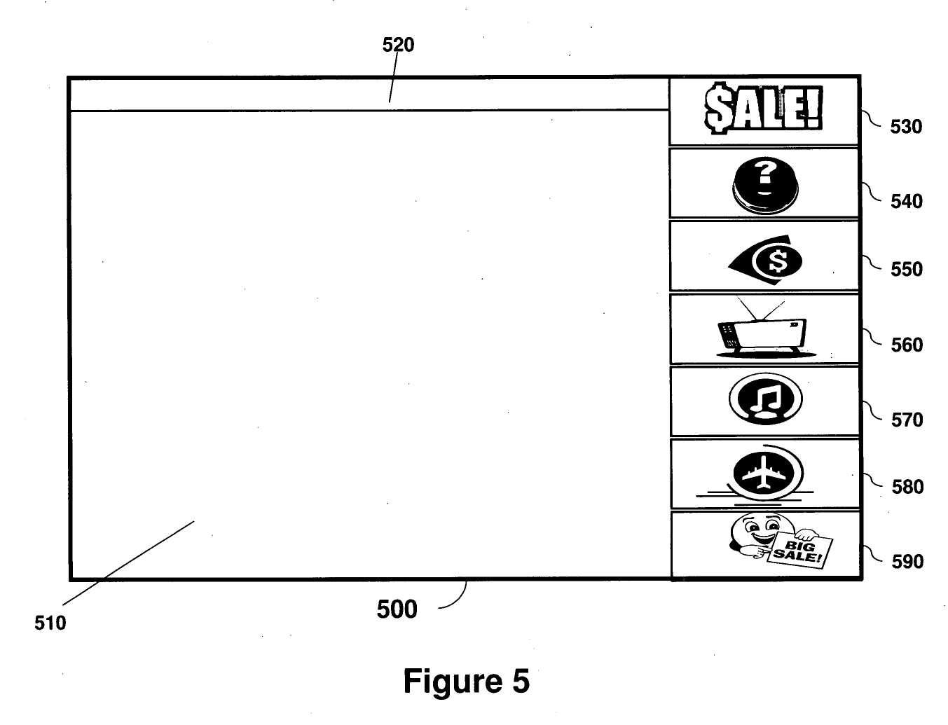

FIG. 5 shows an example of a graphical user interface that exhibits media entertainment as well as advertisements in an embodiment of the disclosed technology. In the example as shown in FIG. 5, a workspace 510 is designated on a monitor 500 of an entertainment console. The workspace 510 can be used to work on undertakings that can be performed on a computer, engage in any media offered, use any networked programs, use any of the console's programs, and other features that are offered on a console. In a further embodiment in the example shown, a ticker bar that can show information that might be of interest to the user. Examples of information that might be displayed on the ticker bar include, but are not limited to, weather information, live customized airline updates, news headlines, and other information that might be of interest to a user. Information that is displayed in the ticker bar 520 can also be selected based on data gleaned about the user, and information clicked on or selected may affect the advertisements displayed, based on the user's interests. Furthermore, in the example shown, there are various subsidiary features 530-590 that contain various graphical modules. These features contain, but are not limited to, advertisements (in video, picture, or text form), fun facts/quizzes, links to networked programs, and the like. It is obvious that these are just examples of how to display the media in the disclosed technology, and any other form of displaying media on a console may be used.

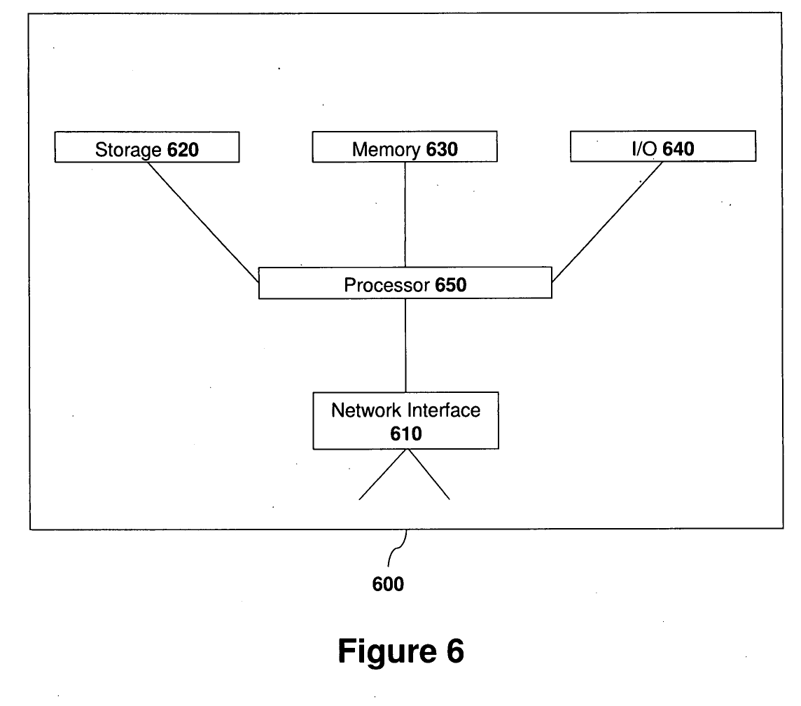

FIG. 6 shows a high-level block diagram of a console that may be used to carry out the disclosed technology. Console 600 contains a processor 650 that controls the overall operation of the console by executing the console's program instructions which define such operation. The program instructions may be stored in a storage device 620 (e.g., magnetic disk, database) and loaded into memory 630 when execution of the program instructions is desired. Thus, the computer operation will be defined by program instructions stored in memory 630 and/or storage 620, and the console will be controlled by processor 650 executing the console's program instructions. Console 600 also includes one or a plurality of input network interfaces for communicating with other devices via a network (e.g., the internet, other consoles within the rest point, etc.). The console 600 also includes one or more output network interfaces 610 for communicating with other devices. Console 600 also includes input/output 640, representing devices which allow for user interaction with the console 600 (e.g., display, keyboard, mouse, speakers, touch screen, buttons, etc.).

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

We claim:

1. A secure access personal entertainment area at a travel point comprising:
an electronically secured entrance further comprising a user input receiving device;
said user input receiving device is configured to glean data from user access identification documents and grant access to a secure entertainment area;
a plurality of entertainment activities within said secure entertainment area; and
advertisements exhibited to said user of said secure access personal entertainment area based, at least in part, upon a point of travel gleaned from a said user access identification document.

2. The secure access personal entertainment area of claim 1, wherein said secure access personal entertainment area comprises an individual booth for each said user.

3. The secure access personal entertainment area of claim 1, wherein said secure access personal entertainment area comprises a console for each said user.

4. The secure access personal entertainment area of claim 1, wherein said user input receiving device is a card reader.

5. The secure access personal entertainment area of claim 4, wherein said card reader is selected from the group consisting of a credit card reader, passport reader, driver license reader, ticket reader, and a combination thereof.

6. The secure access personal entertainment area of claim 1, wherein said point of travel is an origin of travel.

7. The secure access personal entertainment area of claim 6, wherein said origin of travel is gleaned from said user access identification document by said user input receiving device based on at least one of a billing address, a residential address, and a ticket purchase location of a said ticket associated with said user.

8. The secure access personal entertainment area of claim 1, wherein said point of travel is a destination of travel.

9. The secure access personal entertainment area of claim 8, wherein said user access identification document is a ticket granting travel privileges to said user.

10. The secure access personal entertainment area of claim 9, wherein access to said secure access personal entertainment area is granted only after said gleaning of said data from said ticket.

11. The secure access personal entertainment area of claim 10, wherein said advertisements are further based on a class of ticket used to gain entry.

12. The secure access personal entertainment area of claim 1, wherein said advertisements are further based on an ethnicity of said user, and said ethnicity is determined based upon at least one of a name and an origin of travel gleaned from said user access identification document.

13. The secure access personal entertainment area of claim 1, wherein an entertainment activity of said plurality of entertainment activities comprises a media offering and a selection of said media is provided based on said data gleaned from said ticket.

14. The secure access personal entertainment area of claim 13, wherein said advertisements are further based on media chosen by said user.

15. The secure access personal entertainment area of claim 8, wherein said destination is determined based, at least in part, on advertisements acted upon by said user, and further ads displayed are based, at least in part, on said destination.

16. The secure access personal entertainment area of claim 1, wherein sophistication of said user is determined based on advertisements acted upon by said user and further ads displayed are based, at least in part, on said sophistication.

17. The secure access personal entertainment area of claim 1, wherein an entertainment activity of said plurality of entertainment activities comprises shopping for goods or services.

18. The secure access personal entertainment area of claim 17, wherein said advertisements exhibited to said user are based, at least in part, on said goods or services selected for viewing by said user.

19. The secure access personal entertainment area of claim 1, wherein said advertisements exhibited to said user are based, at least in part, on a time of day.

20. A system for providing targeted advertisements to a user using said secure access personal entertainment area of claim 1.
